(19) United States
(12) Patent Application Publication
(10) Pub. No.: US 2012/0024630 A1
(43) Pub. Date: Feb. 2, 2012

(54) Ladder Supported Tree Stand

(76) Inventor: Rodney VanLaningham, Arlington, WA (US)

(21) Appl. No.: 13/189,937

(22) Filed: Jul. 25, 2011

Related U.S. Application Data
(60) Provisional application No. 61/367,913, filed on Jul. 27, 2010.

(51) Int. Cl. A01M 31/02

(52) U.S. Cl. 182/116

(57) ABSTRACT

A tree stand device for use in conjunction with an extension ladder by hunters or nature observers, capable of providing secure footing and support for a user thereon. The device comprises a platform with a tree engagement termination. The tree engagement is a V-shape tree grip that engages the outer surface of the tree and accommodates several different diameters thereof. An adjustable strap is utilized to secure the device to an abutted tree or similar rounded structure. Opposite of the tree engagement is a ladder step saddle, which secures onto the top step of a conventional ladder. An extendable arm angles downward from the stand to engage an additional ladder step with a second step saddle, securely stabilizing the device to the ladder. The strap connection around the tree, in conjunction with engagement of two steps along the ladder provide a stable stand structure for an individual to perch themselves upon for hunting, observation or work support. The device is lightweight and collapsible, allowing easy transport, quick set-up and secure in conjunction with a standard extension ladder.

### CROSS REFERENCE TO RELATED APPLICATION

This application claims the benefit of U.S. Provisional Application No. 61/367,913 filed on Jul. 27, 2010, entitled “Ladder Stand.”

### BACKGROUND OF THE INVENTION

### FIELD OF THE INVENTION

The present invention relates to relates to a deer-hunting stand, a perch for observation or for a secure landing in furtherance of a working individual, constructed as an attachment for a conventional ladder or extension ladder.

Hunters seeking game such as deer conventionally provide themselves with a hunting stand, which is an elevated seating arrangement connected to a tree or other elevated structure, generally above the eye level of the animal being hunted. Such stands may be permanently constructed or assembled as necessary in a specific location. Permanent stands have several disadvantages, most notably their inherent lack of mobility and long setup time.

There have also been suggested in the prior art for various attachments associated with conventional ladders, but these generally have drawbacks inherent to their design. These include those that require special connections with the ladders for proper use, which increases expense and complexity. Some are large and particularly unwieldy, which is not acceptable for a hunting application or similar application where mobility and transportability are paramount. Others lack the ability to collapse into a smaller structure or volume, further reducing transportability.

Conventional ladder stands commonly used by hunters and other users generally comprise a ladder having at one end a horizontal seat or platform mounted perpendicular to the side rails of the ladder. In use, the ladder is extended and leaned against a tree. The user climbs the ladder and sits on the upper platform, sometimes for an extended period, waiting for a deer or other prey animal to show. Alternatively, such devices have been employed by utility workers and those requiring an elevated, stable platform to complete a task.

A key disadvantage of such devices is their inherent instability. In conventional ladder stand devices, the ladder functions not only for climbing but also as a structural support for the platform. In order to best support the platform, the ladder must be positioned perpendicular to the ground. This, however, is not the ideal position for climbing. Rather, the best position for climbing is to position the ladder at a slight angle relative to the tree. This results in a situation, however, where the ladder is not in an ideal position to support the user's load on the platform. To overcome this problem, and the instability created therein, the present invention utilizes a strap or chain that is manually wrapped around the tree trunk to secure the ladder or the platform to the tree to prevent movement of the stand relative to the tree. Further provided is a tree engagement region that bears into the tree utilizing a saw tooth perimeter to accept various trunk sizes while providing adequate engagement thereof.

The present invention therefore relates to a collapsible and portable tree or deer stand having a portable and collapsible platform portion that is attachable to any ladder. The present invention leans against and anchors to the trunk of a tree, utilizing a tree trunk engagement region with a saw tooth pattern and a plurality of ladder step saddles for securement to and support from a leaning ladder. Such a tree stand may be used by wildlife observers, hunters or utility workers as a structure by which such individuals may be provided a stable platform for standing or sitting in an elevated position along a tree trunk or similarly rounded structure.

### DESCRIPTION OF THE PRIOR ART

Numerous devices exist in the field of ladder platforms or stands, and patents have been issued to several related devices. However, these prior art devices have several known drawbacks. Numerous issued patents are related to devices that require custom ladders, thereby limiting flexibility for the user in ladder selection. Additionally, some of the devices require difficult or complex arrangements, using bolts or multiple attachment points to the tree. Further still, there are device that include engagements that only fit a particularly size tree or pole.

Christie, U.S. Pat. No. 3,318,415 is directed to a platform, mountable upon ladders having tubular rungs to assist in retaining such ladders against upright elongated cylindrical objects such as trees, telephone poles or the like. The platform, when supported by the ladder upon such elongated objects, permits worker to prune the tree or otherwise work thereon. The Christie device is not designed for a hunting application and does not provided modularity for multiple uses; rather it fits a set size utility pole to provide workers with an additional platform. The tree or pole must be of a particular size to fit within the platform of the Christie device. Though similar, the Christie patent does not address the issues the present invention addresses, along with the present invention structure, which can inherently accommodate various tree and pole size.

Other devices described by in the art require onerous setup, which is unlikely to be amenable to a hunter in the wild or to a user requiring rapid deployment. Conner U.S. Pat. No. 4,100,999 is directed to an attachment for a ladder to be used as a stand for a deer hunter. The attachment comprises a pair of spaced co-planar side rails forming a first frame and a pair of spaced co-planar top rails forming a second frame and connected to the upper end of the first frame at an angle of about 90°. An upper shelf providing a seat and a lower shelf providing a footrest are pivotably attached the first frame for extending therefrom. Anchors connect the attachment to a ladder. The attachment has a gripping construction for connection to a tree, carried by the second frame. The Connor device requires a series of anchor bolts for a connection to the ladder. Such setup is cumbersome and difficult in an outdoor setting. Further, the Connor device would require the use of ladders capable of accepting the anchor bolts or require modification to a non-compliant ladder. This limits user's choice of ladder or requires modification to an existing ladder, which may not be preferable to the user.

Similar to the Connor device, several devices described in previously issued patents require the use of a custom ladder that is described to work in conjunction with a specialized attachment to the prior art device. Purdy U.S. Pat. No. 4,552,247 is directed to an upstanding ladder including opposite side stiles and vertically spaced horizontal rungs extending between and interconnecting the stiles. A platform has one marginal portion thereof pivotally mounted from the uppermost rung with the platform extending horizontally from one side of the ladder. An outwardly opening V -shaped tree trunk embracing brace interconnects the outer free ends of the arms and seat structure is mounted from the outer ends of the arms and is spaced outward from the base ends of the arms. Further, the ladder comprises vertically aligned upper and lower telescopingly engaged ladder sections with the platform, arms and braces.

Amacker U.S. Pat. No. 5,332,063 is directed to a ladder stand for an upright column member such as a tree, pole or the like. The stand includes a pair of jaws, one of which is remotely moveable so that the platform can be safely secured to the tree before the ladder is climbed. After the user climbs down, the jaws can be disengaged from the tree and the ladder stand removed.

Both the Purdy and Amacker devices require the use of a custom ladder. This severely limits the user's preference in choosing a ladder. If the provided ladder does not meet the user's requirements or breaks, then the whole device is rendered unusable. The present invention provides a modular device that accommodates any ladder with rung-style steps, allowing universal deployment and not requiring the user to employ a specific ladder device.

Similarly, Garbs U.S. Pat. No. 6,719,093 is directed to an extension ladder and tree stand for supporting a person on an elevated platform against a tree trunk for hunting, photography, and the like. The ladder and platform are collapsible into a compact size and shape for carrying. Captive spring loaded pins fix telescoping step sections in extended or retracted positions. A folding seat on the platform has a cushion that reconfigures into a back cushion for carrying the collapsed assembly on the back of a person. Though compact and easily carried, the Garbs device requires an involved setup, as well as using the included and specifically designed ladder. Larger individuals or simply those with a preference my find the included lightweight ladder unsuitable for their needs.

Amacker U.S. Pat. No. 4,742,888 is directed to a folding ladder stand which is adapted to be attached to a tree including a ladder frame having an upper portion and a lower portion, a platform supported on the upper portion of the ladder frame, a collapsible seat mounted above the platform and means for attaching the platform to the tree. A rigid, standoff member is provided adjacent the lower portion of the ladder frame, with the standoff member being provided with further means for attachment to the tree. This device also requires a custom ladder, while the present invention does not. Further, this device requires two attachment points on the tree to be properly secured, making for a more difficult setup than that provided by the present invention. Finally, it is nearly perpendicular to the ground when assembled, thus making for a less stable structure than the present invention, which employs an inclined ladder leaned toward the tree.

Phillips U.S. Pat. No. 5,279,390 is directed to an improved tree stand. The tree stand has a frame with a horizontally extending seat platform and at least one leg extending from the frame for partially supporting the platform in an elevated position against a tree, post, or the like. A V-shaped spike bar having a plurality of spikes extends from one side of the platform for engaging the tree. The spike on a locking arm and the plurality of spikes on the V -shaped spike bar engage the tree to provide opposed securing forces on the tree. The rope circles around the tree and securely ties to prepare the stand for usage. In addition, Phillips U.S. Pat. No. 5,368,127 (Phillips '127) is directed to a tree stand for use in observing and hunting game. The stand forms an elevated platform and means for connecting the stand to a tree. In one aspect of the invention, the seat and footrest can be folded up for ease of transportation. In another aspect, the ladder assembly can be disassembled for ease of transportation. In yet another aspect of the invention, the disassembled ladder sections of the ladder assembly can be mated with a plurality of members on the platform and tied to the platform for secure transportation and storage. As with inventions mentioned above, both Phillips devices require two attachments points, making for a more difficult setup. The Phillips device also does not angle the ladder portions to provide optimal stability. The Phillips '127 device likewise requires a proprietary ladder to function.

Kempf U.S. Pat. No. 5,538,101 is directed to a hunter's tree stand with a platform detachably mounted to an upright mounting bracket that affixes to a tree trunk. A supporting arm pivots about the lower end of the mounting bracket to allow the platform to be leveled. The platform may be easily removed from the mounting bracket or folded up against the tree. A proprietary ladder that may be disassembled for transport, is attachable to the platform. An alternative embodiment provides a platform fixed to a ladder member, for use as a ladder stand. The Kempf inventions suffers a combination of drawbacks previously revealed in the aforementioned prior art patents. The Kempf invention requires a difficult setup method, involving bolts, along with use of a custom ladder. Additionally, only a single attachment to the ladder is provided. The present invention makes use of two attachment points along the ladder for additional stability.

Talley U.S. Pat. No. 5,791,436 is directed to a collapsible tree stand to provide an elevated support for a hunter against a tree trunk. The stand includes an elongated sectional ladder having a platform seat and footrest each pivotally attached to the uppermost ladder section. The platform seat also includes safety front and side rails removably associated with the seat. An anchoring structure is provided for securing the tree stand to the tree. As with previously mentioned devices, the Talley invention requires a complicated means of setup, involves a custom ladder and only has a single attachment point to the ladder.

Other tree stand devices do make use of a conventional ladder; however they are not collapsible and easily transportable. Miller U.S. Pat. No. 6,003,632 is directed to an adapter for converting a conventional ladder to a tree stand ladder that comprises a horizontal platform having a pair of vertical connecting members extending downwardly and from one end of the platform, each connecting member has a port for receiving a top portion of the lateral members of a ladder. The other end of the horizontal platform is provided with a curved portion for mating with a tree or pole, while a ratchet-type locking strap is used to secure the device to the tree. Hunters will often desire a tree stand that is some distance from their car or house. In such instances, the Miller invention would not be suitable, as it fails to provide a collapsible, easily transportable device.

The present invention, therefore, provides a new and unique structure and method for providing a stable platform for use with a standard extension ladder. Despite a crowded field of prior tree stand devices, each has its own drawbacks. Several of the inventions previously mentioned require the use of a custom ladder, limiting the choice of ladder for the user or requiring the purchase of a specialized version. Others are not collapsible and lack transportability, require difficult setup with various bolts and other parts, or offer only a single steadying attachment to the ladder. The tree is the most stable structure in support of the stand, and likely only requires a single attachment point; however, multiple attachment points from the platform to the ladder will provide increased stability. The present invention provides such a device to address the drawbacks and deficiencies presented in the art. Its structure and method of attachment substantially diverges in design elements from the prior art and consequently it is clear that there is a need for an improvement in existing ladder stand devices now present in the art. In this regard the instant invention substantially fulfills this need.

### SUMMARY OF THE INVENTION

In view of the foregoing disadvantages inherent in the known types of tree stands now present in the prior art, the present invention provides a new collapsible and portable tree stand for use with any ladder wherein the same can be utilized for providing convenience for the user when hunting game from a tree or otherwise supporting an individual against a rounded structure.

The present invention affords users the ability to hunt from a tree stand easily and safely. The device allows hunters to achieve elevation, thereby providing concealment and removing their scent from the immediate environment. The device attaches to an extension ladder to create an elevated tree stand without the hassle of employing screw-in steps or a tree ladder. Practitioners will appreciate the safety and simplicity that this device provides.

Further, the present invention provides an attachment that can be quickly affixed to the rungs or steps of conventional ladder, without modification of the ladder itself. The attachment includes a main platform, as well as an additional support brace attachable to the ladder. A unique tree engagement region accommodates various tree and rounded structure diameter, while its saw tooth construction allows the stand to bear into the tree for improved stability. A strap or chain is wrapped around the perimeter of the tree for further securement of the platform, while the ladder is place in an angled position for improved access to the stand and confidence on the ladder.

It is therefore an object of the present invention to provide a hunting stand that may be readily attached to a conventional ladder without requiring modification of the ladder itself.

Another object of the present invention is to provide a ladder stand with improved stability, with a plurality of attachment locations to a ladder and a secure engagement with the tree.

Still another object of the present invention is to provide a deer hunting, observation or utility worker's stand that is attachable to a ladder, and one that is economical, transportable and made of conventional and readily obtainable materials, and one which is lightweight and easily deployable.

It is a further object of the present invention to provide a platform that secures safely and easily to trees or poles of varying sizes. Further, the device should be secured to the tree with a minimum number of attachment points, while providing optimum stability for the practitioner while the invention is in use.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself, and manner in which it may be made and used, may be better understood by referring to the following description taken in connection with the accompanying drawings.

FIG. 1 is a perspective view of the present invention unfolded for attachment to a ladder.

FIG. 2 is a perspective view of the present invention attached to a conventional ladder and affixed against a tree.

FIG. 3 is a perspective view of the present invention collapsed for transport and storage.

### DETAILED DESCRIPTION OF THE INVENTION

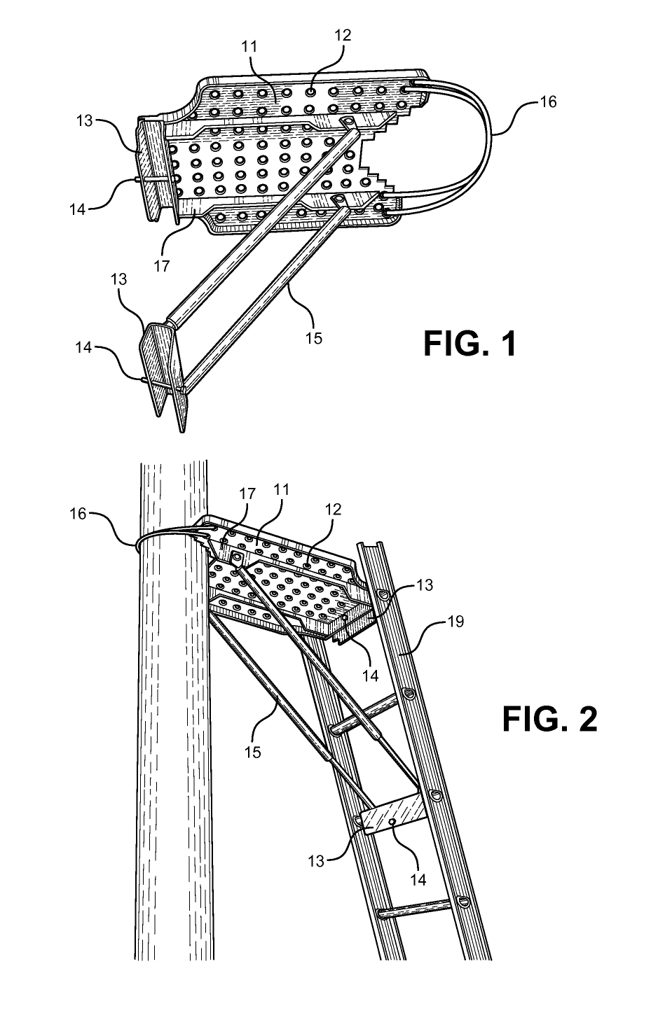

Referring now to FIG. 1, there is shown a perspective view of the present invention unfolded for attachment to a ladder. A platform 11 with a plurality of apertures 12 to reduce weight and improve traction is shown. The first end of the platform includes a tree gripping, saw tooth V-shape with an adjustable strap 16 for further securing to the circumference of a tree. The adjustable strap 16 is attached to two corner holes in the platform 11, and is placed in tension around the tree to draw the tree grip into the tree. The grip bears into the tree and utilizes the saw tooth configuration for further engagement. A step saddle 13 with locking pin 14 is attached to the second end of the platform 11. The saddle 13 is a U-shaped structure that accommodate a ladder step or rung, while the locking pin 14 slots into place after the step has been engaged to lock the two together and prevent dislocation. The platform 11 is reinforced with stiffener panels 17, to which a pair of adjustable arms 15 are attached. The adjustable arms 15 are further attached to a second ladder step saddle 13 and securing pin 14 for attachment to a lower ladder step.

Referring now to FIG. 2, there is shown a perspective view of the present invention attached to a conventional ladder 19 and affixed against a tree. The tree gripping, V-shaped end of the platform is affixed to the tree using the adjustable strap 16. The step saddle 13 on the second end of the platform 11 is secured to the top step of the ladder and secured in place with a locking pin 14. The adjustable arms 15 extend towards a lower step along the ladder for engagement with a second saddle 13. The combination of both a top step and lower step attachment provides a structurally stable configuration, in the shape of a triangle structure. The ladder 19 is prevented from sliding away from the tree, and thus collapsing the stand, while the strap 16 and tree grip ensure static positioning of the first end of the stand.

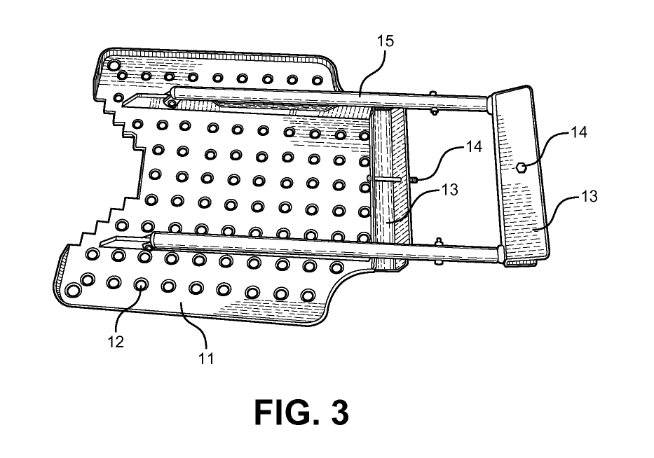

Referring now to FIG. 3, there is shown a perspective view of the present invention collapsed for transport or storage. The adjustable arms 15 are retracted against the base of the platform 11, providing a collapsed device that can lie flat when not in use. Shoulder straps or another carrying means may be attached through the corner holes of the platform or through any of the plurality of apertures 12 provided thereon. Both ladder step saddles and locking pins are secured against the platform 11 in this configuration.

The present invention provides a sturdy, lightweight design that can be safely and stably deployed while hunting. The device may be constructed of lightweight aluminum or sufficiently sturdy lightweight material to provide support for a large individual at an elevated position. The apertures 12 along the stand reduce weight and provide improved traction for the user. The number, arrangement and style of the apertures are not intended to be limited to the configuration shown in the figures. Rather, the figures are desired to be illustrative examples of an exemplary embodiment of the present invention. Attached to the bottom of the platform 11 are two platform stiffener panels 17 to reduce deflection of the platform under load and to provide attachment for the articulating, adjustable legs that engage the second set of steps along the ladder. The arrangement of the tree grip is designed to accommodate various diameter poles, trees or rounded structures, while still providing a design that includes sharp edges for proper securement and engagement thereto. The saw tooth pattern allows the grip to bear into the tree or pole for increased friction, while the strap provides securement by increasing the bearing force between the tree and grip.

In use, the present invention is unfolded from a stowed position. The ladder step saddles 13 are secured to the conventional ladder 19 with locking pins 14. The ladder step saddle 13 attached to the platform 11 is affixed to the top step of the ladder 19, while the ladder step saddle 13 on the terminal end of the adjustable arms 15 is secured over a lower step on the ladder 19. The device is then propped against a tree with the tree gripping terminus of the platform engaging the exterior surface of tree. The adjustable strap 16 is then secured around the tree, effectively affixing the device in place. When the device is folded for transport, shoulder straps may be secured through the corner holes of the platform 11 allowing the practitioner to carry the device on his or her back.

Hunting from a tree stand has become a proven method for harvesting game animals, however many hunters feel as though the tree stands currently on the market are inadequate or require particular equipment for use. Using screw in steps or tree ladders can be difficult and unsafe for a hunter, particularly one that is hunting alone with no peer support. The present invention provides an easily deployable device that is no cumbersome to use, and can accommodate existing equipment for immediate use. The stand is stable, functional and readily manufacturable for use as a hunting stand, observation post or worker support.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A collapsible platform to provide support for a hunter or worker in a tree in conjunction with a ladder, comprising:
a platform with a first tree gripping end and a second ladder step saddle end;
said tree gripping end further comprising a saw tooth V-shape adapted to conform to and engage a rounded structure of varying diameter;
an adjustable strap attached to said first end, adapted to wrap around said rounded structure and secure said gripping end thereto;
said second saddle end comprising a U-shaped cross section, and adapted to fit over a ladder rung or step and secured about said rung or step using a locking pin;
and a pair of adjustable arms extending downward from said platform and terminating at a second ladder step saddle, adapted to secure over a second step of said ladder and affixing thereto via a second locking pin.

2. The device as in claim 1, further comprising a plurality of apertures in said platform to decrease weight and improve traction.

3. The device as in claim 1, further comprising a shoulder strap or other means of transport.

4. The device as in claim 1, further comprising a plurality of vertical stiffener panels supporting said platform from below and extending from said first end to said second end.
